(19) United States
(12) Patent Application Publication
(10) Pub. No.: US 2011/0019004 A1
(43) Pub. Date: Jan. 27, 2011

(54) IMAGING DEVICE, IMAGING METHOD, IMAGING CONTROL PROGRAM, AND PORTABLE TERMINAL DEVICE

(75) Inventors: Kenji OHMORI, Kanagawa (JP); Takashi YAMAMOTO, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY ERICSSON MOBILE COMMUNICATIONS AB, Lund (SE)

(21) Appl. No.: 12/821,476

(22) Filed: Jun. 23, 2010

(30) Foreign Application Priority Data
Jul. 23, 2009 (JP) 2009-171969

(51) Int. Cl. H04N 5/33; H04N 5/335

(52) U.S. Cl. 348/164; 348/280; 348/E05.091; 348/E05.09

(57) ABSTRACT

An imaging device includes an imaging element, a color filter, a read control unit, an infrared component quantity detection unit, and an infrared component removing unit. The imaging element includes a large number of pixels in a light receiving surface. The color filter includes, a large number of red, green, and blue filter units, and a plurality of infrared-transparent filter units extracting the infrared component of imaging light incident substantially on a center and peripheral areas of the light receiving surface. The read control unit controls reading out of the imaging element. The infrared component quantity detection unit detects the infrared component quantity contained in the imaging light received at each pixel. The infrared component removing unit outputs the imaging data after removing the quantity of infrared component detected by the infrared component quantity detection unit from the imaging data obtained from each of the RGB pixels.

### BACKGROUND OF THE INVENTION

1. Field of the Invention

The present invention relates to an imaging device, imaging method, imaging control program, and portable terminal device that are suitably applicable to still-image and/or moving-image capturing devices employing an imaging element to capture the images of subjects, as well as to portable telephones, PHS (personal handyphone system) telephones, PDA (personal digital assistant) devices, portable game machines, notebook personal computer devices, or other devices equipped with a camera function employing an imaging element to capture the images of subjects.

The present invention relates in particular to an imaging device, imaging method, imaging control program, and portable terminal device in which a color filter includes red (R), green (G), and blue (B) filter units arranged in a two-dimensional array on a light receiving surface of an imaging element, as well as a plurality of infrared-transparent filter units disposed at positions substantially corresponding to the center and peripheral areas of the light receiving surface of the imaging element to detect the quantity of infrared component in these areas of the light receiving surface of the imaging element on the basis of imaging data obtained from the pixels associated with the infrared-transparent filter units, and remove the detected quantity of infrared component from imaging data obtained from the pixels associated with the R, G, or B filter units, so that an optimum quantity of infrared component can be removed from the imaging data obtained from each pixel in the light receiving surface of the imaging element.

2. Description of the Related Art

Today, a small camera module is installed in many portable terminal devices, such as portable telephones in particular. This camera module includes, as shown in FIG. 7, a diaphragm unit (aperture unit) 104 and an infrared cut filter 105, which are disposed in this order, between a lens unit 101 installed in the front face of a camera module housing 100 and an imaging element 103 installed on a substrate 102.

A semiconductor imaging element such as a CMOS (complementary metal oxide semiconductor) imaging element or a CCD (charge coupled device) imaging element is provided as the imaging element 103. As shown in FIG. 8A, each pixel in the imaging element 103 is very sensitive to wavelengths reaching an infrared region that are longer than the wavelengths of visible light recognizable by the human eye.

To extract from imaging light the red (R), green (G), and blue (B) components corresponding to the sensitivity of the human eye, a color filter 106 is typically provided on the light receiving surface of the imaging element 103 as shown in FIG. 8B.

The color filter 106 includes filter unit groups each formed by four color filter units surrounded by the bold line as shown in FIG. 9. Each filter unit group has a red filter unit (R), a first green filter unit (Gb) disposed next to the red filter unit (R) in the same column, a blue filter unit (B) disposed next to the first green filter unit (Gb) in the same row, and a second green filter unit (Gr) disposed next to the red filter unit (R) in the same row and next to the blue filter unit (B) in the same column. The color filter 106 includes a large number of such filter unit groups arranged in an array including a large number of rows and columns on the light receiving surface of the imaging element 103.

Infrared rays may not be removed as desired with the color filter 106 alone. If the infrared ray is not removed as desired, the remaining infrared ray would offset the outputs from the R, G, and B pixels, leading to inconsistency in color reproducibility.

To prevent this problem, an infrared cut filter 105 is provided in front of the color filter 106 and removes the infrared component from the imaging light before the imaging light enters the color filter 106.

The imaging element 103 receives on its pixels the red component of the imaging light extracted by the red filter units (R) of the color filter 106, the blue component of the imaging light extracted by the blue filter units (B), and the green component of the imaging light extracted by the green filter units (Gr, Gb), and forms and outputs the imaging data corresponding to the red component of the imaging light, the imaging data corresponding to the green component of the imaging light, and the imaging data corresponding to the blue component of the imaging light. The imaging data corresponding to these color components are later synthesized in the process by a synthesizing circuit (not illustrated) and displayed, recorded, or otherwise processed as a color image.

Japanese Unexamined Patent Application Publication No. 2008-091535 discloses a solid-state imaging device including pixels formed with color filters that block infrared rays and color filters that transmit only infrared rays, and capturing a visible light image and an infrared image simultaneously at the same angle of view.

### SUMMARY OF THE INVENTION

As shown in FIG. 7, a small camera module installed in portable terminal devices has a very short optical length and a very wide chief ray angle (CRA) due to its thin structure. The chief ray angle refers to the angle of incidence of imaging light on the peripheral areas of the light receiving surface of the imaging element 103. The infrared cut filter 105 provided to remove the infrared component has an optical property of attenuating at a higher attenuation rate the infrared component of the imaging light entering at a wider angle of incidence.

The infrared component of the imaging light entering the peripheral areas of the light receiving surface of the imaging element 103 at a higher angle of incidence is attenuated at a higher attenuation rate than the infrared component of the imaging light substantially perpendicular to the center of the light receiving surface of the imaging element 103. The difference in attenuation rate between the center and the peripheral areas of the light receiving surface causes concentric color shading (image unevenness) with the center of a captured image reddish and its peripheral areas bluish as shown in FIG. 10A.

Such color shading can be reduced later by correcting the color-difference signals (color shading correction) in the center and peripheral areas of the captured image by an image processing unit (ISP: image signal processor) after the processing performed by the imaging element 103.

This color shading correction is effective for the images captured in a sunlight environment or in an indoor environment in which one or more incandescent lamps are used as a light source, because the sunlight and incandescent light contain a large quantity of infrared component as shown in FIG. 8C. On the other hand, the light emitted from a fluorescent lamp scarcely contains the infrared component.

If the color shading correction is applied to the images captured in an indoor environment in which one or more fluorescent lamps are used as a light source, reversed color shading (image unevenness) will occur in the captured image with the center bluish and the peripheral areas reddish as shown in FIG. 10B, because infrared components are removed from the captured image that originally contains little infrared component.

The color shading correction could be effectively achieved and the occurrence of the reversed color shading could be prevented if the color shading correction function is turned on when capturing images in a light source environment where the quantity of infrared component is large and turned off in a light source environment where the quantity of infrared component is small, the light source environment being determined by detecting the brightness and color temperature of the environment light.

In this case, however, the color shading correction function might be turned on or off incorrectly and the reversed color shading might occur, because the color shading correction is turned on or off depending on the light source environment determined on the basis of the brightness or color temperature of the environment light.

It is desirable to provide an imaging device, imaging method, imaging control program, and portable terminal device that can remove an optimum quantity of infrared component at each pixel in the light receiving surface of the imaging element in any light source environment and substantially prevent the occurrence of the color shading and reversed color shading.

According to an embodiment of the present invention, there is provided an imaging device. The imaging device includes an imaging element that includes a large number of pixels in a light receiving surface for receiving imaging light and outputs as imaging data a charge corresponding to the imaging light received at each pixel; a color filter provided on the light receiving surface of the imaging element, the color filter including a large number of red filter units extracting a red component of the imaging light, a large number of green filter units extracting a green component of the imaging light, a large number of blue filter units extracting a blue component of the imaging light, and a plurality of infrared-transparent filter units extracting an infrared component of the imaging light incident substantially on a center and peripheral areas of the light receiving surface of the imaging element, the filter units being disposed in a predetermined arrangement in a same plane so that one of the filter units is disposed on each of the pixels; a read control unit controlling reading out of the imaging element so that the imaging data corresponding to the imaging light received at each pixel of the imaging element through each filter unit in the color filter is read out of the imaging element; an infrared component quantity detection unit detecting a quantity of infrared component contained in the imaging light received at each pixel on the basis of the imaging data read out of the pixel associated with each infrared-transparent filter unit among the imaging data read out of the pixels by the read control unit; and an infrared component removing unit outputting the imaging data after removing the quantity of infrared component detected by the infrared component quantity detection unit from the imaging data obtained from each of the pixels receiving the imaging light through the red, green, or blue filter unit, the pixels being disposed around the pixel on which the infrared component is detected.

The color filter according to this embodiment includes, together with the red, green, and blue filter units, a plurality of infrared-transparent filter units extracting the infrared component from the imaging light incident substantially on the center and peripheral areas of the light receiving surface of the imaging element.

The infrared component quantity detection unit detects the quantity of infrared component contained in the imaging light received at each pixel, on the basis of the imaging data read out of the pixel associated with each infrared-transparent filter unit among the imaging data read out of the imaging element by the read control unit, and the infrared component removing unit outputs the imaging data after removing the quantity of infrared component detected by the infrared component quantity detection unit from the imaging data obtained from the pixels receiving the imaging light through the red, green, or blue filter unit, the pixels being disposed around the pixel on which the infrared component is detected.

According to the embodiment, an optimum quantity of infrared component can be removed, under any light source environment, from the imaging data received at each pixel in the light receiving surface of the imaging element, and thereby the occurrence of color shading or reversed color shading can substantially be prevented.

Since a large number of infrared-transparent filter units are provided within the color filter, the infrared-transparent filter that has been provided independently of the color filter can be omitted, so a camera module or a portable terminal device according to the embodiment of the present invention can be implemented with a simple and thin structure and at a low cost.

### BRIEF DESCRIPTION OF THE DRAWINGS

FIG. 1 is a block diagram of a portable telephone according to an embodiment of the present invention;

FIG. 2 illustrates the internal structure of a main camera unit provided in the portable telephone according to the embodiment of the present invention;

FIG. 3 is a schematic diagram of a color filter provided in the main camera unit of the portable telephone according to the embodiment of the present invention;

FIG. 4 is a flowchart illustrating the flow of an infrared removing process in the portable telephone according to the embodiment of the present invention;

FIG. 5 is a functional block diagram of the control unit during the infrared removing process in the portable telephone according to the embodiment of the present invention;

FIG. 6 is a schematic diagram of another color filter provided in the main camera unit of the portable telephone according to the embodiment of the present invention;

FIG. 7 illustrates the internal structure of a typical camera module in the past and the chief ray angle;

FIG. 8A illustrates the difference in sensitivity between the human eye and the imaging element;

FIG. 8B illustrates the optical characteristics of the color filter units;

FIG. 8C illustrates the quantities of the infrared component contained in rays of light from different light sources;

FIG. 9 is a schematic diagram of a color filter provided in a typical camera module in the past; and

FIGS. 10A and 10B illustrate color shading that occurs in a small camera module, and reversed color shading caused by the correction of the color shading.

### DESCRIPTION OF THE PREFERRED EMBODIMENTS

An embodiment of the present invention is applicable, for example, to a flip-type portable telephone having a camera function.

### [Structure of the Portable Telephone]

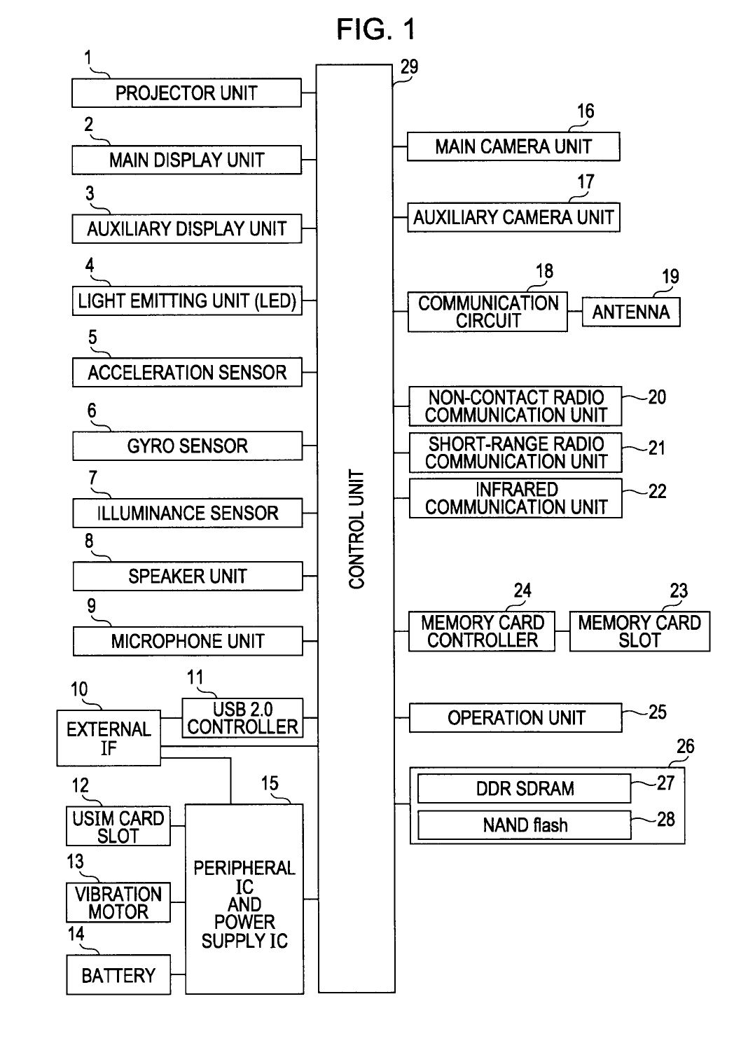

FIG. 1 shows the block diagram of a portable telephone according to an embodiment of the present invention. A projector 1 provided in the portable telephone in FIG. 1 is a front projection type projector, for example, and includes a liquid crystal panel displaying the original image to be projected, a light source emitting projection light to the liquid crystal panel, and a projection optical system projecting the original image displayed on the liquid crystal panel to a screen or the like. Projectors are broadly classified by the type of projection into liquid crystal projectors and digital light processing (DLP) projectors; the projector 1 may be either one of these two types.

A main display unit 2 is formed from a liquid crystal display (LCD) unit or an organic electro luminescence (OEL) display unit and is disposed in the unexposed surface of the upper housing of the portable telephone (the surface facing the lower housing when the portable telephone is closed). An auxiliary display unit 3 is formed from a liquid crystal display (LCD) unit or an organic electro luminescence (OEL) display unit, similarly to the main display unit 2, and is disposed in the exposed surface of the upper housing (the surface opposite to the surface in which the main display unit 2 is disposed). A light emitting unit (LED: light emitting diode) 4 includes various light sources provided in the portable telephone, such as an incoming alert lamp and an illumination lamp on the operation unit 25 in FIG. 1.

An acceleration sensor 5 detects the magnitude and orientation of acceleration of the physical vibration when the physical vibration is applied to the portable telephone. A gyro sensor 6 detects the rotation angle and angular velocity in the direction of rotation of physical vibration when the physical vibration is applied to the portable telephone. An illuminance sensor 7 detects the brightness of the ambient environment of the portable telephone.

A speaker unit 8 is provided near the top end of the upper housing (the end opposite to the hinged-end) to output the sound received during telephone conversation. A microphone unit 9 is provided near the bottom end of the lower housing (the end opposite to the hinged-end) to input the sound to be transmitted during telephone conversation.

An external interface unit (external IF) 10 includes various external connectors and an external connection unit for signaling with the external connectors or other purposes. These external connectors include USB 2.0 (universal serial bus 2.0) connectors. The portable telephone is, accordingly, also equipped with a USB 2.0 controller 11.

A USIM (universal subscriber identity module) card slot 12 is an IC card slot receiving a USIM card on which subscriber information (contractor information) of the communication company of the portable telephone and other information are stored.

A vibration motor 13, which is popularly called vibrator, vibrates the housing of the portable telephone at the time of call origination or termination to notify the user of the origination or termination of a call. A battery 14 is the power supply supplying the electric power used by the units of the portable telephone. A peripheral IC and power supply IC unit 15 is connected to the USIM card slot 12, vibration motor 13, battery 14, and external interface unit 10 and controls these units, processes signals, controls the recharging of the battery 14, and controls power supply to the units, for example.

The main camera unit 16 is disposed in the exposed surface of the lower housing (the surface opposite to the surface facing the upper housing when the portable telephone is closed) and includes, for example, an imaging element such as a CMOS (complementary metal oxide semiconductor) image sensor or a CCD (charge coupled device) image sensor, an optical system, and an imaging device.

The imaging element such as the CMOS or CCD image sensor includes a large number of pixels arranged in an array formed by a large number of rows (horizontal direction) and columns (vertical direction). Each pixel accumulates a charge corresponding to the imaging light from the subject and outputs the accumulated charge as the imaging data when it is read. The main camera unit 16 having such an imaging element is mainly used to capture the images of a desired subject.

An auxiliary camera unit 17 includes an imaging element, an optical system, and an imaging device and is disposed, together with the speaker unit 8 outputting the sound received during telephone conversation, near the top end of the unexposed surface of the upper housing. The auxiliary camera unit 17 is mainly used as the self-imaging camera unit used by the user of the portable telephone to photograph himself/herself during video telephone conversation.

A communication circuit 18 is the radio communication circuit used by the portable telephone to communicate with a radio base station in a mobile telephone network. An antenna 19 is the antenna used for radio communication between the portable telephone and a radio base station.

A non-contact radio communication unit 20 uses electromagnetic induction to establish non-contact radio communications over a communication range of approximately 50 cm with an external reader/writer. A short-range radio communication unit 21 establishes short-range radio communications over a communication range of approximately 10 m by using, for example, a Bluetooth® or other short-range radio communication scheme. An infrared communication unit 22 establishes infrared radio communications over a communication range of several meters.

A memory card slot 23 detachably receives an external memory card such as an SD (Secure Digital®) card, for example. A memory card controller 24 controls the read/write operations on the memory card inserted in the memory card slot 23 and processes signals.

An operation unit 25 is equipped with a plurality of operation keys and is disposed in the unexposed surface of the lower housing (the surface facing the main display unit 2 of the upper housing when the portable telephone is closed). An internal memory 26 includes, for example, a DDR SDRAM (double data rate SDRAM) 27 and a NAND-type flash memory 28.

The NAND-type flash memory 28 stores operating system (OS) programs, various application programs including control programs used by the control unit 29 to control each unit, an imaging control program for controlling the imaging operation of the main camera unit 16 and auxiliary camera unit 17, and a projection control program for controlling the projecting operation of the projector 1, as well as compression-encoded music, moving image, and still image data contents, various settings, font data, various dictionary data, model name information, terminal identification information, and other information. The NAND-type flash memory 28 also stores a telephone directory including the telephone number, e-mail address, residential address, full name, picture of the face, etc. of each user, as well as e-mails that have been sent and received, a schedule book in which a schedule of the user of the portable telephone is recorded, etc.

The DDR SDRAM 27 serves as a working area and stores data as necessary when the control unit 29 carries out various data processing and computing operations.

The control unit 29 controls communications, controls the imaging operations of the camera units 16, 17 according to the imaging control program described above, controls the sound and/or image processing, processes various signals, and controls each unit, for example, by executing various control programs and application programs stored in the internal memory 26 and processing various relevant data.

It should be appreciated that, although not shown in FIG. 1, the portable telephone according to this embodiment also includes other components that are provided in a typical portable telephone.

### [Structure of the Main Camera Unit]

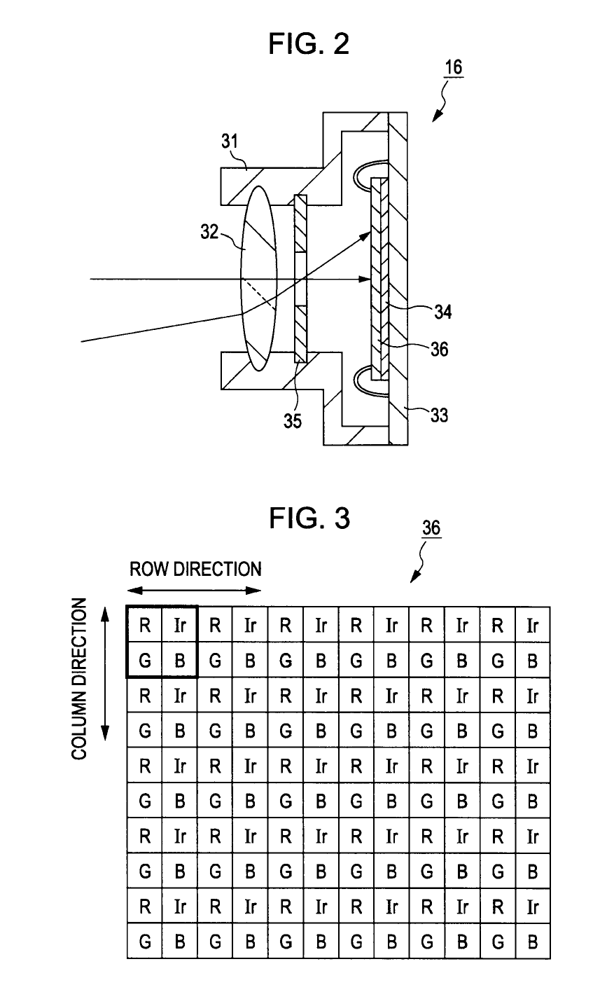

As shown in FIG. 2, the main camera unit 16 includes a diaphragm unit (aperture unit) 35 between the lens unit 32 provided in the front face of the housing 31 of the main camera unit 16 and the imaging element 34 provided on the substrate 33. The main camera unit 16 is significantly reduced in size with a shorter distance between the lens unit 32 and the imaging element 34 because the infrared cut filter is omitted for the reason described below.

In the main camera unit 16 thus constructed, a color filter 36 is provided on the light receiving surface through which the imaging light enters the imaging element 34. As shown in FIG. 3, the color filter 36 includes one infrared-transparent filter unit (Ir) for each filter unit group formed by one red filter unit (R), one green filter unit (G), and one blue filter unit (B).

More specifically, the filter unit group surrounded by the bold line in FIG. 3 includes one red filter unit (R), one green filter unit (G) disposed next to the red filter unit (R) in the same column, one blue filter unit (B) disposed next to the green filter unit (G) in the same row, and one infrared-transparent filter unit (Ir) disposed next to the red filter unit (R) in the same row and next to the blue filter unit (B) in the same column. The color filter 36 is formed from these filter unit groups arranged in an array including a large number of rows and columns on the light receiving surface of the imaging element 34.

Each pixel of the imaging element 34 receives the imaging light through one of the color filter units (R, G, or B), or through the infrared-transparent filter unit (Ir). The infrared-transparent filter units (Ir) are accordingly scattered all over the light receiving surface of the imaging element 34.

The auxiliary camera unit 17 has the same structure as the main camera unit 16. For details, reference should be made to the description of the main camera unit 16.

[Infrared Removing Operation in the Main Camera Unit]

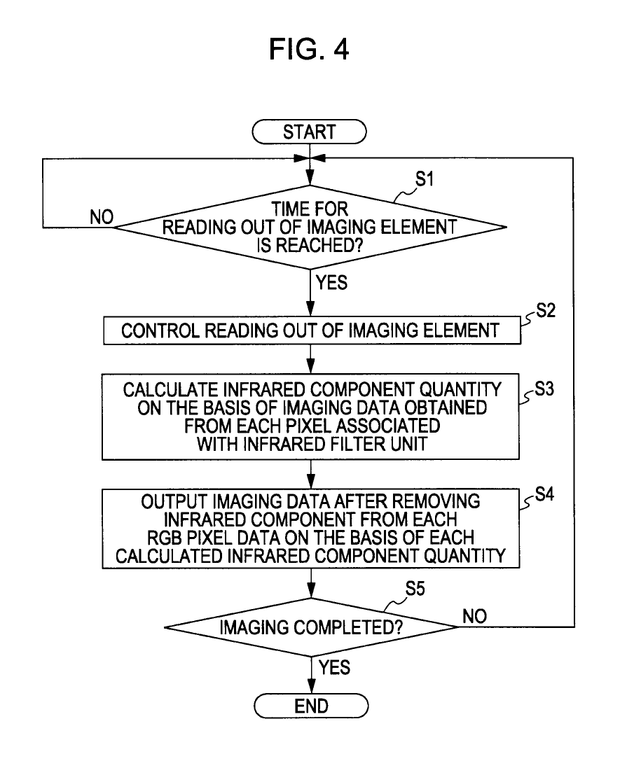

When a moving or still image is captured, the control unit 29 provided in the portable telephone thus structured carries out an infrared removing process to remove the infrared component from the imaging data obtained from each pixel in the imaging element 34, according to the imaging control program stored in the NAND-type flash memory 28. The flowchart in FIG. 4 shows the flow of the infrared removing process carried out by the control unit 29. When an operation specifying the capturing of a moving or still image is performed on the operation unit 25, the control unit 29 controls the activation of the main camera unit 16 according to the imaging control program and starts the process shown in the flowchart in FIG. 4.

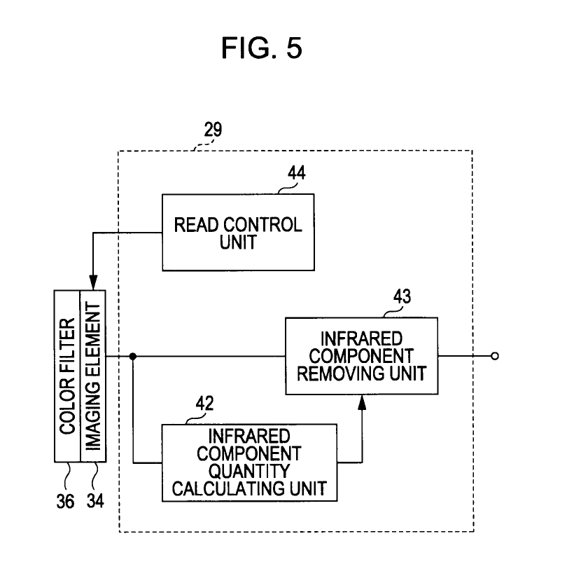

In step S1, the control unit 29 decides whether or not the time for reading out the charge accumulated in each pixel of the imaging element 34, such as 1/60 second for example, is reached, on the basis of the timing information supplied by a timer not shown; if it is decided the time for reading out the charge is reached, the processing proceeds to step S2. In step S2, the control unit 29 functions as the read control unit 44 shown in FIG. 5 to read out the imaging data, i.e., the charge accumulated in each pixel of the imaging element 34, according to the imaging control program described above, and the processing proceeds to step S3.

More specifically, the imaging light from the subject enters each pixel of the imaging element 34 through the lens unit 32, diaphragm unit (aperture unit) 35, and color filter 36, in this order, in the main camera unit 16.

The red filter units (R) in the color filter 36 extract the red component of the imaging light entering the pixels of the imaging element 34 through the red filter units (R). The pixels in the imaging element 34 receiving the imaging light through the red filter units (R), accordingly, receive the red component of the imaging light.

Similarly, the green filter units (G) in the color filter 36 extract the green component of the imaging light entering the pixels through the green filter units (G). The pixels in the imaging element 34 receiving the imaging light through the green filter units (G), accordingly, receive the green component of the imaging light.

Similarly, the blue filter units (B) in the color filter 36 extract the blue component of the imaging light entering the pixels through the blue filter units (B). The pixels in the imaging element 34 receiving the imaging light through the blue filter units (B), accordingly, receive the blue component of the imaging light.

Similarly to the color filter units, the infrared-transparent filter units (Ir) in the color filter 36 extract the infrared component of the imaging light entering the pixels through the infrared-transparent filter units (Ir). The pixels in the imaging element 34 receiving the imaging light through the infrared-transparent filter units (Ir), accordingly, receive the infrared component of the imaging light.

The imaging data read out of the pixels of the imaging element 34 in step S2, accordingly, includes the imaging data representing the red component of the imaging light that is read out of the pixels receiving the imaging light through the red filter units (R), the imaging data representing the green component of the imaging light that is read out of the pixels receiving the imaging light through the green filter units (G), the imaging data representing the blue component of the imaging light that is read out of the pixels receiving the imaging light through the blue filter units (B), and the imaging data representing the quantity of infrared component contained in the imaging light that is read out of the pixels receiving the imaging light through the infrared-transparent filter units (Ir).

After the imaging data is read out of the imaging element 34 as described above, the control unit 29 functions as the infrared component quantity calculation unit 42 shown in FIG. 5, to calculate in step S3 the quantity of infrared component contained in the imaging light received at each pixel, on the basis of the imaging data read out of each pixel receiving the imaging light through the infrared-transparent filter unit (Ir), and then the processing proceeds to step S4.

In step S4, the control unit 29 functions as the infrared component removing unit 43 shown in FIG. 5 to output the imaging data after removing the infrared component calculated in step S3 from the imaging data obtained from the pixels associated with the R, G, or B filter units. The imaging data from which the infrared component was removed are later synthesized in a synthesizing circuit or the like in the process and displayed as one color image on the main display unit 2 or stored in the internal memory 26.

The control unit 29 iterates the processing in steps S1 through S4 until an operation specifying the completion of imaging is performed in step S5.

Steps S3 and S4 will be described in detail below. The control unit 29 functions as the infrared component quantity calculating unit 42 in step S3 and as the infrared component removing unit 43 in step S4 to carry out the following calculations to obtain imaging data tDR, tDG, and tDB, which are the R, G, and B imaging data from which the infrared component has been excluded. In the following equations, DR, DG, and DB represent the imaging data obtained from the pixels associated with the R, G, or B color filter units, and DIr represents the imaging data obtained from the pixel associated with the infrared-transparent filter unit (Ir).

tDR=DR−fR(DIr),

tDG=DG−fG(DIr), and

tDB=DB−fB(DIr),

where fR(DIr), fG(DIr), and fB(DIr) are the equations for calculating the quantity of infrared component contained in the imaging data DR, DG, and DB obtained from the R, G, and B pixels, on the basis of the imaging data DIr obtained from the pixel associated with the infrared-transparent filter unit (Ir).

The above equations for calculating the quantity of infrared component contained in the imaging data DR, DG, and DB obtained from the R, G, and B pixels may be replaced with coefficients that are calculated in advance.

In the portable telephone according to this embodiment, the color filter 36 includes one infrared-transparent filter unit (Ir) for each color filter group formed by one red filter unit (R), one green filter unit (G), and one blue filter unit (B), as shown in FIG. 3, surrounded by the bold line. The quantity of infrared component is detected, accordingly, in each filter unit group.

Carrying out the infrared component removing operation based on the above equations removes an exact quantity of infrared component in each group of color filter units (i.e., an exact quantity of infrared component can be removed for each one of the R, G, and B pixels).

[Effects of this Embodiment]

As is apparent from the foregoing description, in the portable telephone according to this embodiment, the color filter 36 provided on the light receiving surface of the imaging element 34 in the main camera unit 16 includes one infrared-transparent filter unit (Ir) for each color filter unit group formed by one red filter unit (R), one green filter unit (G), and one blue filter unit (B). The quantity of infrared component is detected in each group on the basis of the imaging data obtained from the pixel associated with the infrared-transparent filter unit (Ir) and is removed from the R, G, and B imaging data obtained from this group. With this, an exact quantity of infrared component can be removed in each group.

Since the infrared component is removed in each group, the infrared component can be removed optimally at all R, G, and B pixel locations in any imaging environment, irrespective of the type of light source used, whether the Sun or a fluorescent lamp, for example.

Since an exact quantity of infrared component can be removed in each group, the infrared cut filter that was provided in front of the imaging element 34 in the past can be omitted. Even if the optical length is very short in a small-sized main camera unit 16, it is possible to prevent the occurrence of color shading caused by the difference in attenuation rate of the infrared component attenuated by the infrared cut filter due to the difference in angle of incidence of the imaging light on the infrared cut filter.

Since the infrared component can be removed optimally at all R, G, and B pixel locations in any imaging environment irrespective of the type of light source, whether the Sun or a fluorescent lamp, for example, the reversed color shading can be prevented as well, which is caused by applying the color shading correction to the imaging data obtained from imaging under a light scarcely containing the infrared component, such as the light from the fluorescent lamp.

Since the infrared cut filter can be omitted and both the color shading and the reversed color shading can be prevented, the main camera unit 16 can be further reduced in size and thickness, contributing to the reduction in size and thickness of the portable telephone.

In the camera unit for portable terminal devices, it is difficult at present to employ a lens having a f-number greater than 2.8, because of the size, cost, depth of field, or other factors. Such a problem is expected to continue.

At present, CMOS image sensors are mainly employed as the imaging elements for portable terminal devices. There is a CMOS image sensor in which a pixel pitch of 1.4 μm is achieved as the result of continuous downsizing and increase in the number of pixels.

Even if the pixel pitch of the CMOS image sensor is further reduced, however, the lens in the camera unit for the above portable terminal devices will not provide an optical performance equivalent to the optical resolution provided by the pixels arranged at micro pitches.

The resolution of CMOS image sensors today exceeds the optical resolution of the lens employed in the camera units for the portable terminal devices.

The resolution of the CMOS image sensor provided in the portable telephone according to this embodiment exceeds the optical resolution of the lens unit 32, so the optical resolution of the lens unit 32 can be maintained even if the infrared-transparent filter units (Ir) are provided in the color filter 36. It is possible, accordingly, to detect and remove the quantity of infrared component at each pixel location while maintaining the optical resolution of the lens unit 32. The image quality of the captured image can be maintained, accordingly, even if the infrared-transparent filter units (Ir) are provided in the color filter 36.

### [First Variant of the Portable Telephone According to the Embodiment]

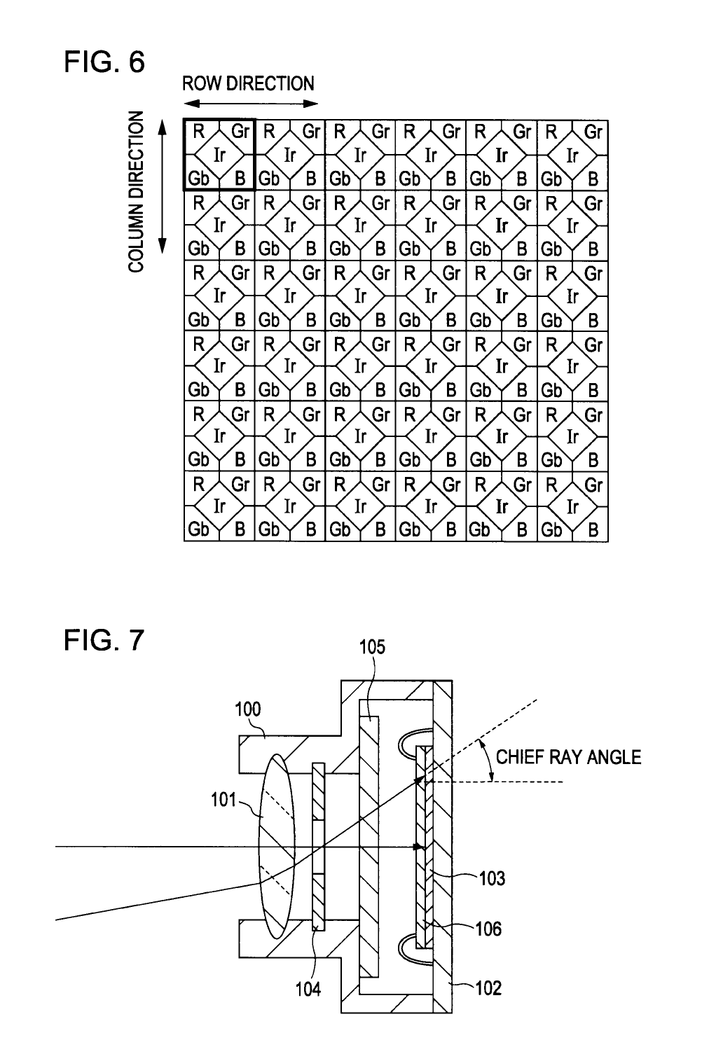

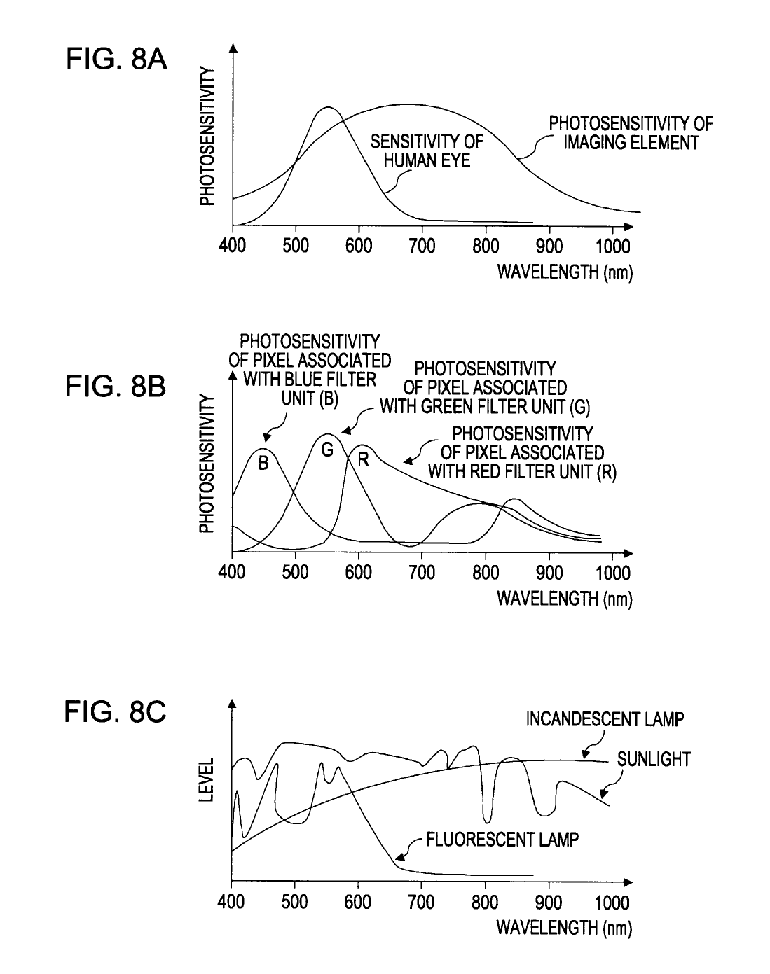

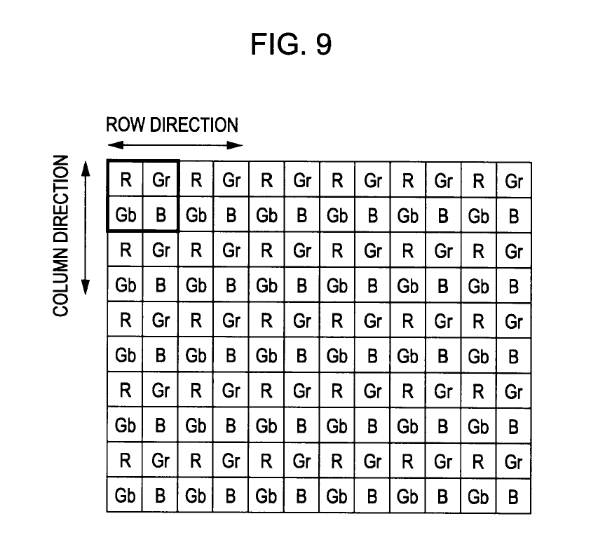

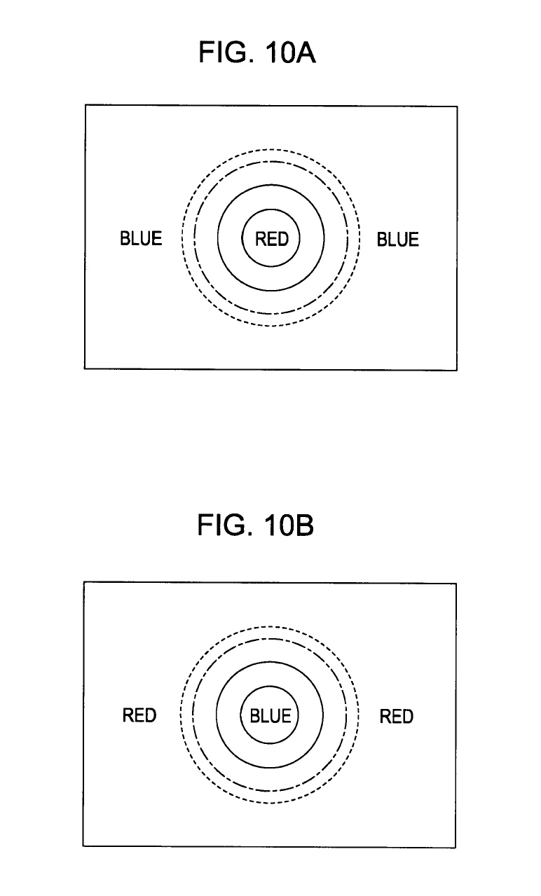

The color filter 36 provided in the main camera unit 16 of the portable telephone according to the embodiment described above includes one infrared-transparent filter unit (Ir) for each color filter unit group formed by one red filter unit (R), one green filter unit (G), and one blue filter unit (B) as shown in FIG. 3. Alternatively, the color filter 36 may be formed as shown in FIG. 6.

The color filter 36 shown in FIG. 6 includes one infrared-transparent filter unit (Ir) for each color filter unit group formed by one red filter unit (R), two green filter units (Gr, Gb), and one blue filter unit (B).

More specifically, in FIG. 6, the filter unit group surrounded by the bold line includes a red filter unit (R), a first green filter unit (Gb) disposed next to the red filter unit (R) in the same column, a blue filter unit (B) disposed next to the first green filter unit (Gb) in the same row, and a second green filter unit (Gr) disposed next to the red filter unit (R) in the same row and next to the blue filter unit (B) in the same column, as well as one infrared-transparent filter unit (Ir) disposed substantially at the center of this group.

When the color filter 36 shown in FIG. 6 is provided on the imaging element 34, the infrared component is removed similarly as described above. More specifically, the quantity of infrared component is detected in each group on the basis of the imaging data obtained from the pixel associated with the infrared-transparent filter unit (Ir) and is removed from the imaging data obtained from each of the R, B, and two G pixels in this group. With this, an exact quantity of infrared component can be removed in each group and the same effect is achieved as in the portable telephone according to the embodiment described earlier.

The color filter 36 shown in FIG. 6 includes more green filter units than the color filter 36 shown in FIG. 3. Since the human eye is highly sensitive to the green component of the light, images can be captured at a higher resolution through the color filter 36 shown in FIG. 6 than through the color filter 36 shown in FIG. 3.

### [Second Variant of the Portable Telephone According to the Embodiment]

In the portable telephone according to the embodiment described earlier and in the portable telephone in the first variant, the infrared-transparent filter unit (Ir) provided in the color filter 36 extracts the infrared component of the imaging light. Alternatively, the infrared-transparent filter unit (Ir) provided in the color filter 36 shown in FIGS. 3 and 6 may be made transparent to a full-wavelength light (i.e., non filtering) and the quantity of infrared component to be removed in each group may be calculated on the basis of the imaging data obtained from the pixel associated with this filter unit transparent to the full-wavelength light.

In this case, the control unit 29, when functioning as the infrared component quantity calculating unit 42 in step S3 of the flowchart in FIG. 4 and as the infrared component removing unit 43 in step S4, carries out the following calculations to obtain imaging data tDR, tDG, and tDB, which are the R, G, and B imaging data from which the infrared component has been removed. In the following equations, DR, DG, and DB represent the imaging data obtained from the pixels associated with the R, G, and B color filter units, and Dall represents the imaging data obtained from the pixel associated with the infrared-transparent filter unit (Ir).

tDR=DR−fR(Dall−DR−DG−DB),

tDG=DG−fG(Dall−DR−DG−DB), and

tDB=DB−fB(Dall−DR−DG−DB),

where fR(Dall−DR−DG−DB), fG(Dall−DR−DG−DB), and fB(Dall−DR−DG−DB) are the equations for calculating the quantity of infrared component contained in each of the imaging data DR, DG, DB obtained from the R, G, and B pixels, on the basis of the imaging data Dall obtained from the pixel associated with the infrared-transparent filter unit (Ir).

The above equations for calculating the quantity of infrared component contained in the imaging data DR, DG, and DB obtained from the R, G, and B pixels may be replaced with coefficients that are calculated in advance.

By carrying out the infrared component removing processing based on these equations, an exact quantity of infrared component can be removed in each group and the same effect as in the portable telephone according to the embodiment described earlier or in the first variant described above can be achieved.

### [Other Variants]

In the portable telephone according to the embodiment described earlier and the portable telephone in each variant, the color filter 36 includes one infrared-transparent filter unit (Ir) for each color filter unit group formed by one red filter unit (R), one or two green filter units (G, or Gr and Gb), and one blue filter unit (B), so that the infrared-transparent filter units (Ir) are scattered all over the light receiving surface of the imaging element 34. Alternatively, the infrared-transparent filter units (Ir) may be disposed in the color filter 36 so that the infrared-transparent filter units (Ir) are scattered in areas corresponding to substantially the center and peripheral areas of the light receiving surface of the imaging element 34.

In this case, the control unit 29 removes from the imaging data obtained from the R, G, and B pixels located substantially at the center of the light receiving surface of the imaging element 34 the quantity of infrared component calculated on the basis of the imaging data obtained from the pixels associated with the infrared-transparent filter units (Ir) scattered in the area corresponding to substantially the center of the light receiving surface of the imaging element 34, and from the imaging data obtained from the R, G, and B pixels located in the peripheral areas of the light receiving surface of the imaging element 34 the quantity of infrared component calculated on the basis of the imaging data obtained from the pixels associated with the infrared-transparent filter units (Ir) scattered in the areas corresponding to the peripheral areas of the light receiving surface of the imaging element 34.

With this, the infrared component can be removed separately in the center and peripheral areas of the light receiving surface of the imaging element 34, so the same effect as with the cases described above can be achieved.

In the portable telephone according to the embodiment described earlier and each variant, the color filter 36 is formed including one infrared-transparent filter unit (Ir) for each color filter unit group formed by one red filter unit (R), one or two green filter units (G, or Gr and Gb), and one blue filter unit (B). Alternatively, the color filter 36 may be formed including one infrared-transparent filter unit (Ir) for each two or more color filter unit groups. In this case, the infrared component can be removed effectively again at the R, G, and B pixel locations, so the same effect as that described above can be achieved.

In the description described above, the embodiment and each variant are applied to a portable telephone equipped with a camera function. The embodiment and each variant are also applicable to PHS (personal handyphone system) telephones, PDA (personal digital assistant) devices, portable game machines, notebook personal computers, or other devices equipped with a camera function, as well as to still- and/or moving-image capturing devices and other devices employing an imaging element to capture the images of subjects. In each of these cases, the same effect as that described above can be achieved.

The present application contains subject matter related to that disclosed in Japanese Priority Patent Application JP 2009-171969 filed in the Japan Patent Office on Jul. 23, 2009, the entire content of which is hereby incorporated by reference.

The above description illustrates an example of the present invention. It should be appreciated that the present invention is not limited to the above description and various modifications can be made depending on design requirements and other factors without departing from the technical ideas according to the present invention.

What is claimed is:

1. An imaging device comprising:
an imaging element that includes a large number of pixels in a light receiving surface for receiving imaging light and outputs as imaging data a charge corresponding to the imaging light received at each pixel;
a color filter provided on the light receiving surface of the imaging element, the color filter including a large number of red filter units extracting a red component of the imaging light, a large number of green filter units extracting a green component of the imaging light, a large number of blue filter units extracting a blue component of the imaging light, and a plurality of infrared-transparent filter units detecting an infrared component of the imaging light incident substantially on a center and peripheral areas of the light receiving surface of the imaging element, the filter units being disposed in a predetermined arrangement in a same plane so that one of the filter units is disposed on each of the pixels;
a read control unit controlling reading out of the imaging element so that the imaging data corresponding to the imaging light received at each pixel of the imaging element through each filter unit in the color filter is read out of the imaging element;
an infrared component quantity detection unit detecting an infrared component quantity contained in the imaging light received at each pixel, on the basis of the imaging data read out of the pixel associated with the infrared-transparent filter unit among the imaging data read out of the pixels by the read control unit; and
an infrared component removing unit outputting the imaging data after removing the quantity of infrared component detected by the infrared component quantity detection unit from the imaging data obtained from each of the pixels receiving the imaging light through the red, green, or blue filter unit, the pixels being disposed around the pixel on which the infrared component is detected.

2. The imaging device according to claim 1, wherein the color filter includes filter unit groups each having one infrared-transparent filter unit, one red filter unit, one or two green filter units, and one blue filter unit.

3. The imaging device according to claim 2, wherein, in each filter unit group in the color filter, the green filter unit is disposed next to the red filter unit in a same column, the blue filter unit is disposed next to the green filter unit in a same row, and the infrared-transparent filter unit is disposed next to the red filter unit in a same row and next to the blue filter unit in a same column.

4. The imaging device according to claim 2, wherein, in each filter unit group in the color filter, a first green filter unit is disposed next to the red filter unit in a same column, the blue filter unit is disposed next to the first green filter unit in a same row, a second green filter unit is disposed next to the red filter unit in a same row and next to the blue filter unit in a same column, and the infrared-transparent filter unit is disposed substantially at a center of each group.

5. An imaging method comprising the steps of:
controlling reading out of an imaging element that includes a large number of pixels in a light receiving surface for receiving imaging light and outputs as imaging data a charge corresponding to the imaging light received at each pixel so that the imaging data corresponding to the imaging light received at each pixel of the imaging element through each filter unit in a color filter is read out of the imaging element, the color filter including a large number of red filter units extracting a red component of the imaging light, a large number of green filter units extracting a green component of the imaging light, a large number of blue filter units extracting a blue component of the imaging light, and a plurality of infrared-transparent filter units extracting an infrared component of the imaging light incident substantially on a center and peripheral areas of the light receiving surface of the imaging element, the filter units being disposed in a predetermined arrangement in a same plane on the light receiving surface of the imaging element so that one of the filter units is located above each of the pixels;
detecting an infrared component quantity contained in the imaging light received at each pixel, on the basis of the imaging data read out of the pixel associated with each infrared-transparent filter unit among the imaging data read out of the pixels in the step of controlling reading out of the imaging element; and
outputting the imaging data after removing the quantity of infrared component detected in the step of detecting the infrared component quantity, from the imaging data obtained from each of the pixels receiving the imaging light through the red, green, or blue filter unit, the pixels being disposed around the pixel on which the infrared component is detected.

6. An imaging control program causing a computer to function as:
a read control unit controlling reading out of an imaging element that includes a large number of pixels in a light receiving surface for receiving imaging light and outputs as imaging data a charge corresponding to the imaging light received at each pixel so that a read control unit reads out the imaging data corresponding to the imaging light received at each pixel of the imaging element through each filter unit in a color filter, the color filter including a large number of red filter units extracting a red component of the imaging light, a large number of green filter units extracting a green component of the imaging light, a large number of blue filter units extracting a blue component of the imaging light, and a plurality of infrared-transparent filter units extracting an infrared component of the imaging light incident substantially on a center and peripheral areas of the light receiving surface of the imaging element, the filter units being disposed in a predetermined arrangement in a same plane on the light receiving surface of the imaging element so that one of the filter units is disposed on each of the pixels;
an infrared component quantity detection unit detecting an infrared component quantity contained in the imaging light received at each pixel, on the basis of the imaging data read out of the pixel associated with each infrared-transparent filter unit among the imaging data read out of the pixels by the computer functioning as the read control unit; and
an infrared component removing unit outputting the imaging data after removing the quantity of infrared component detected by the computer functioning as the infrared component quantity detection unit, from the imaging data obtained from each of the pixels receiving the imaging light through the red, green, or blue filter unit, the pixels being disposed around the pixel on which the infrared component is detected.

7. A portable terminal device including an imaging device, the imaging device comprising:
an imaging element that includes a large number of pixels in a light receiving surface for receiving imaging light and outputs as imaging data a charge corresponding to the imaging light received at each pixel;
a color filter provided on the light receiving surface of the imaging element, the color filter including a large number of red filter units extracting a red component of the imaging light, a large number of green filter units extracting a green component of the imaging light, a large number of blue filter units extracting a blue component of the imaging light, and a plurality of infrared-transparent filter units extracting an infrared component of the imaging light incident substantially on a center and peripheral areas of the light receiving surface of the imaging element, the filter units being disposed in a predetermined arrangement in a same plane so that one of the filter units is disposed on each of the pixels;
a read control unit controlling reading out of the imaging element so that the imaging data corresponding to the imaging light received at each pixel of the imaging element through each filter unit in the color filter is read out of the imaging element;
an infrared component quantity detection unit detecting an infrared component quantity contained in the imaging light received at each pixel, on the basis of the imaging data read out of the pixel associated with each infrared-transparent filter unit among the imaging data read out of the pixels by the read control unit; and
an infrared component removing unit outputting the imaging data after removing the quantity of infrared component detected by the infrared component quantity detection unit from the imaging data obtained from each of the pixels receiving the imaging light through the red, green, or blue filter unit, the pixels being disposed around the pixel on which the infrared component is detected.
